(19) United States
(12) Patent Application Publication
(10) Pub. No.: US 2025/0245574 A1
(43) Pub. Date: Jul. 31, 2025

(54) TRAINING DATA GENERATING SYSTEM, TRAINING DATA GENERATING METHOD, AND INFORMATION STORAGE MEDIUM

(71) Applicant: Rakuten Group, Inc., Tokyo (JP)

(72) Inventor: Wendkuuni Moise CONVOLBO, Tokyo (JP)

(73) Assignee: Rakuten Group, Inc., Tokyo (JP)

(21) Appl. No.: 19/184,187

(22) Filed: Apr. 21, 2025

Related U.S. Application Data
(63) Continuation of application No. 17/032,766, filed on Sep. 25, 2020.

(30) Foreign Application Priority Data
Sep. 27, 2019 (JP) 2019-176820

(51) Int. Cl. G06N 20/00; G06F 3/0482; G06F 18/214; G06F 18/23; G06F 18/2413; G06F 18/40; G06N 20/20

(52) U.S. Cl. CPC G06N 20/00; G06F 3/0482; G06F 18/214; G06F 18/23; G06F 18/24137; G06F 18/40; G06N 20/20

(57) ABSTRACT

A training data generating system includes at least one processor configured to cluster a plurality of classification objects, present content of some of the classification objects belonging to a cluster to an analyst, assign a label specified by the analyst to the cluster, and generate training data to be learned by a learning model based on the label.

### CROSS-REFERENCE TO RELATED APPLICATION

The present application is a Continuation of U.S. application Ser. No. 17/032,766 filed Sep. 25, 2020, which claims priority from Japanese application JP2019-176820 filed on Sep. 27, 2019, the content of which is hereby incorporated by reference into the application.

### BACKGROUND OF THE INVENTION

### 1. Field of the Invention

The present disclosure relates to a training data generating system, a training data generating method, and an information storage medium.

### 2. Description of the Related Art

There are known techniques for analyzing a behavior history of a user on a website, for example. For example, JP2011-022799A describes a system in which an excellent screen transition route that can efficiently reach a conversion screen, such as a member registration screen, is specified based on the screen transition of a user on a website, and a screen that prevents the user from reaching the conversion screen or a screen that lowers the conversion is detected.

### SUMMARY OF THE INVENTION

In the above techniques, analyzing a behavior history of a user using a learning model with training data is examined. For example, when specifying the excellent screen transition route using the learning model, the system of JP2011-022799A needs to generate training data by assigning a label indicating whether the screen transition of the user is the excellent screen transition route so as to train the learning model.

However, there are many screen transition patterns to reach the conversion screen, and thus it is difficult to prepare an assignment rule that covers every screen transition pattern, even if the training data is automatically generated by preparing the assignment rule of the label. On the other hand, it is very troublesome and not efficient to manually assign labels so as to generate training data.

One object of the present disclosure is to efficiently generate training data.

A training data generating system according to one aspect of the disclosure includes at least one processor configured to cluster a plurality of classification objects, present content of some of the classification objects belonging to a cluster to an analyst, assign a label specified by the analyst to the cluster, and generate training data to be learned by a learning model based on the label.

A training data generating method according to one aspect of the disclosure includes clustering a plurality of classification objects, presenting content of some of the classification objects belonging to a cluster to an analyst, assigning a label specified by the analyst to the cluster, and generating training data to be learned by a learning model based on the label.

A non-transitory information storage medium according to one aspect of the disclosure stores a program that causes a computer to cluster a plurality of classification objects, present content of some of the classification objects belonging to a cluster to an analyst, assign a label specified by the analyst to the cluster, and generate training data to be learned by a learning model based on the label.

### BRIEF DESCRIPTION OF THE DRAWINGS

FIG. 1 is a diagram illustrating an overall configuration of the training data generating system;

FIG. 2 is a diagram showing an example of configuration of a website provided by a server;

FIG. 3 is a diagram showing an example of clustering;

FIG. 4 is a diagram showing an example of the label assigning screen;

FIG. 5 is a diagram showing an example of a label assigning screen when an analyst selects a cluster;

FIG. 6 is a diagram showing how content of a behavior history is displayed on the label assigning screen;

FIG. 7 is a diagram showing an example of the label assigning screen when a straggle label is assigned to the cluster;

FIG. 8 is a functional block diagram illustrating an example of functions implemented by the training data generating system;

FIG. 9 is a diagram illustrating an example of data storage of behavior history data;

FIG. 10 is a diagram illustrating an example of data storage of domain knowledge data;

FIG. 11 is a diagram illustrating an example of data storage of a training data set;

FIG. 12 is a flow chart showing an example of processing executed in the training data generating system;

FIG. 13 is a flow chart showing an example of processing executed in the training data generating system; and

FIG. 14 is a functional block diagram of a variation.

### DETAILED DESCRIPTION OF THE INVENTION

### 1. Overall Configuration of Training Data Generating System

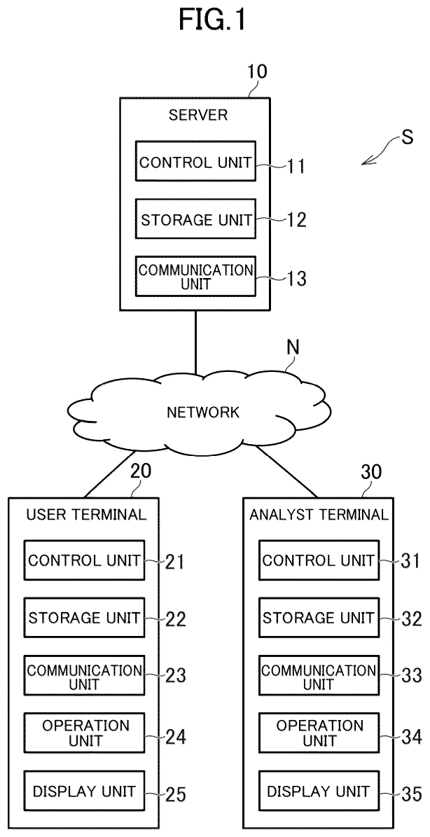

An embodiment of the training data generating system according to the present disclosure will be described below. FIG. 1 is a diagram illustrating an overall configuration of the training data generating system. As shown in FIG. 1, the training data generating system S includes a server 10, a user terminal 20, and an analyst terminal 30, which are connectable to a network N, such as the Internet. FIG. 1 shows one server 10, one user terminal 20, and one analyst terminal 30, although the number of each of them may be two or more.

The server 10 is a server computer and includes, for example, a control unit 11, a storage unit 12, and a communication unit 13. The control unit 11 includes at least one processor. The control unit 11 executes processing according to programs or data stored in the storage unit 12. The storage unit 12 includes a main storage unit and an auxiliary storage unit. For example, the main storage unit is a volatile memory such as a RAM, and the auxiliary storage unit is a nonvolatile memory such as a hard disk and a flash memory. The communication unit 13 includes a wired or wireless communication interface for data communications through the network N, for example.

The user terminal 20 is a computer operated by a user, such as a personal computer, a portable information terminal (including a tablet computer), and a mobile phone (including a smartphone). The user is a user of the service provided by the server 10, for example, a viewer of a web site. The user can be referred to as an end user.

The user terminal 20 includes a control unit 21, a storage unit 22, a communication unit 23, an operation unit 24, and a display unit 25. The hardware configuration of the control unit 21, the storage unit 22, and the communication unit 23 may be the same as that of the control unit 11, the storage unit 12, and the communication unit 13. The operation unit 24 is an input device for a user to perform operations, for example, a pointing device such as a touch panel and a mouse, and a keyboard. The operation unit 24 transmits an operation of the user to the control unit 21. The display unit 25 is, for example, a liquid crystal display unit or an organic EL display unit.

The analyst terminal 30 is a computer operated by an analyst, such as, a personal computer, a portable information terminal, and a mobile phone. The analyst is a person in charge of analyzing user behaviors, for example, a data scientist at a service provider.

The analyst terminal 30 includes a control unit 31, a storage unit 32, a communication unit 33, an operation unit 34, and a display unit 35. The hardware configuration of the control unit 31, the storage unit 32, the communication unit 33, the operation unit 34, and the display unit 35 may be the same as that of the control unit 11, the storage unit 12, the communication unit 13, the operation unit 24, and the display unit 25.

The programs and data described as being stored in the storage units 12, 22, and 32 may be provided to these units through a network. The hardware configuration of the server 10, the user terminal 20, and the analyst terminal 30 is not limited to the above examples, and can adopt various types of hardware. For example, the server 10, the user terminal 20, and the analyst terminal 30 may each include a reader (e.g., optical disc drive and memory card slot) for reading a computer-readable information storage medium, and an input/output unit (e.g., USB port) for directly connecting to external devices. In this case, the programs and data stored in the information storage medium may be provided to each of the server 10, the user terminal 20, and the analyst terminal 30 through the reader or the input/output unit.

### 2. Overall Configuration of Training Data Generating System

The outline of the training data generating system S will be described. The training data generating system S assigns a label to each of classification objects, and generates training data to be learned by a learning model.

The classification object is data (information) to be classified. In other words, the classification object is data to which a label is assigned. The classification object may be assigned with a label by the analyst and become part of the training data, or may be entered into a learning model and assigned with a label. The classification object may be data of any format, for example, data of a user's behavior history, an image captured by a camera, a text such as a news article and an editorial, content such as music and video, and a website.

The label is an identifier that uniquely identifies a classification. The label may also be referred to as an attribute, type, category, or class. In this embodiment, the label is different from a cluster described later. The label may be represented by a character string indicating the label name, or by an ID uniquely identifying the label. The label may be binary information indicating whether it belongs to a predetermined classification, or may be information indicating which of a plurality of classifications it belongs to.

The learning model is a model using machine learning. The learning model may also be referred to as AI (Artificial Intelligence), a classifier, or a classification learner. The learning model can perform any processing, such as human behavior analysis, image recognition, character recognition, speech recognition, and natural phenomenon recognition. Various known methods can be used for the machine learning itself. For example, methods such as neural network, reinforcement learning, and deep learning can be used. For the machine learning, supervised machine learning or semi-supervised machine learning may be used.

The training data is data that the learning model learns. The training data may also be referred to as learning data or teacher data. For example, the training data is a pair of an input (question) to the learning model and an output (answer) of the learning model. For example, the training data is a pair of data (labeled classification object) having the same format as the input data (unknown classification object) entered into the learning model, and the label assigned to the data.

The machine learning is performed by using a plurality of pieces of training data, and thus, a group of training data is described as a training data set, and each data included in the training data set is described as training data in this embodiment. That is, a part described as the training data means the pair described above, and the training data set means a group of pairs.

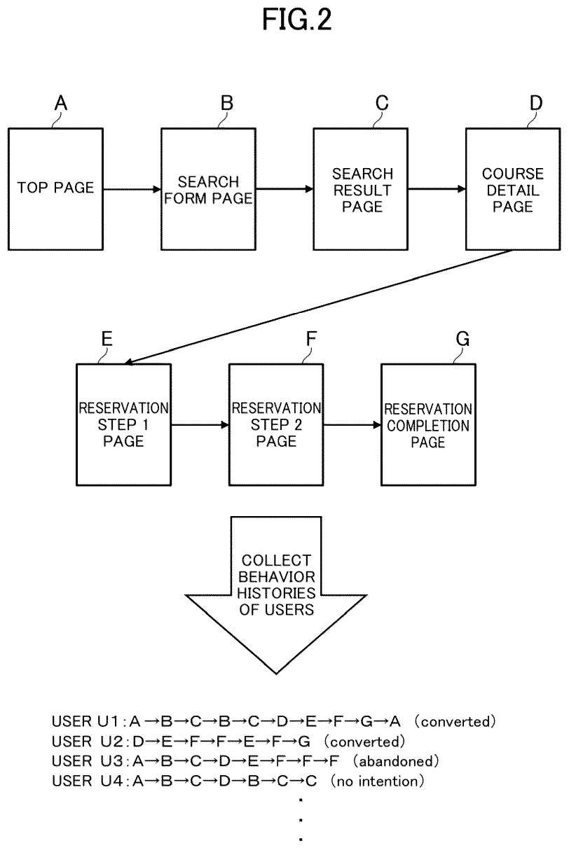

In this embodiment, taking an example of a scene in which a behavior of a user in a website provided by the server 10 is analyzed, the processing of the training data generating system S will be described. As such, in this embodiment, a behavior history of the user corresponds to the classification object. For example, the behavior history includes screen transitions of the user on the website and an input of the user in the screen. FIG. 2 is a diagram showing an example of configuration of a website provided by the server 10. In this embodiment, a web site accepting a reservation of a golf course will be described as an example of a web site. As shown in FIG. 2, when the screen shifts in the order of a top page A, a search form page B, a search result page C, a course detail page D, a reservation step 1 page E, a reservation step 2 page F, and a reservation completion page G, the reservation of the golf course is completed.

The top page A is a top-level page serving as an entrance to a reservation service of the golf course. If the website has a tree structure (hierarchical structure), the top page A corresponds to a root node. The search form page B is a page for inputting search conditions (queries) of the golf course. The search form page B displays input forms for inputting search conditions, such as, an area of the golf course, a play start date and time, and the number of players.

The search result page C is a page displaying a list of golf courses searched by the search conditions. The course detail page D is a page showing details of a course in a golf course. For example, the course detail page D displays the golf course selected from the search result page C. In the example of FIG. 2, only one course detail page D is shown, although there are as many course detail pages D as the number of courses for which the server 10 can accept reservations. As such, if the user does not like the golf course in the displayed course detail page D, the user can return to the search result page C and display a course detail page D of another golf course.

Each of the reservation step 1 page E and reservation step 2 page F is a page for entering information necessary for reservation of a golf course. For example, the reservation step 1 page E displays input forms for entering a start time and the number of players. For example, the reservation step 2 page F displays input forms for entering a name, address, telephone number, mail address of a person who makes the reservation, and names of other players.

In this embodiment, all the input forms in the reservation step 1 page E must be filled out, otherwise the process does not proceed to the reservation step 2 page F. For example, if there is information that is not entered in the reservation step 1 page E, the process cannot proceed to the reservation step 2 page F even if a button for proceeding to the reservation step 2 page F is selected. In this case, the reservation step 1 page E is displayed again, and an error message indicating missing information is displayed at a predetermined position.

The reservation completion page G indicates that the reservation for the golf course has been completed. In this embodiment, all the input forms in the reservation step 2 page F must be filled out, otherwise the process does not proceed to the reservation completion page G. As such, similarly to the reservation step 1 page F, if there is any missing information in the reservation step 2 page F, the process cannot proceed to the reservation completion page G and an error message is displayed.

The user does not necessarily have to perform the screen transitions in the order described above, and can perform the screen transitions in any order. For example, if the user bookmarks the link of the course detail page D, the course detail page D may be displayed at first without displaying the top page A, the search form page B, and the search result page C. For example, the user can move back and forth between the search result page C and the course detail page D to find a desired golf course, or return to the top page A from the reservation completion page G.

In this embodiment, the server 10 collects and stores behavior histories of a large number of users who have accessed in the past. In the example shown in FIG. 2, the behavior history of a user U1 shows screen transitions in the order of the top page A, the search form page B, the search result page C, the search form page B, the search result page C, the course detail page D, the reservation step 1 page E, the reservation step 2 page F, the reservation completion page G, and the top page A. The user U1 moves back and forth between the search form page B and the search result page C, but the reservation of the golf course is completed because the user U1 reaches the reservation completion page G. In this embodiment, when the reservation completion page G is displayed, the purpose of the reservation service of the golf course is achieved. As such, the display of the reservation completion page G means so-called conversion.

A user U2 performs screen transitions in the order of the course detail page D, the reservation step 1 page E, the reservation step 2 page F, the reservation step 2 page F, the reservation step 1 page E, the reservation step 2 page F, and the reservation completion page G. The reservation step 2 page F appears twice in a row, because there is missing information in the reservation step 2 page F and the process cannot proceed to the reservation completion page G. The operation returns to the reservation step 1 page E from the reservation step 2 page F, because the user U2 has checked and corrected the content entered in the reservation step 1 page E. Although there are some problems, the user U2 has also reached the reservation completion page G, which means it is converted.

A user U3 performs screen transitions in the order of the top page A, the search form page B, the search result page C, the course detail page D, the reservation step 1 page E, the reservation step 2 page F, the reservation step 2 page F, and the reservation step 2 page F. The reservation step 2 page F appears three times in a row, because there is missing information in the reservation step 3 page F and the process cannot proceed to the reservation completion page G.

For example, assume that the user U3 is unable to recognize the error message due to a problem in the layout of the reservation step 2 page F, and has left the website in the middle because the user U3 is unwilling to enter the information. As such, it is assumed that the user U3 had an intention to reserve the golf course, but could not reach the reservation completion page G. In the following, this situation (the reservation step 1 page E or the reservation step 2 page F is displayed, but the user has not reached the reservation completion page G) is referred to as “abandonment”.

A user U4 performs screen transitions in the order of the top page A, the search form page B, the search result page C, the course detail page D, the search form page B, the search result page C, and the search result page C. The user U4 has displayed the course detail page D but has not displayed the reservation step 1 page E, and thus it is assumed that the user U4 had no intention to reserve the golf course but merely browsed the website. In the following, this situation (at least one of the top page A, the search form page B, the search result page C, and the course detail page D is displayed, but the user has not reached the reservation step 1 page E) is referred to as “no intention”.

In this embodiment, as described above, the behavior of moving back and forth between a plurality of pages or displaying the same page many times is called straggle behavior. The straggle behavior is a behavior that is converted but not easily converted, or a behavior that is intended to be converted but not converted. In other words, the straggle behavior is an indication that an obstacle to conversion has occurred. The straggle behavior can also be seen as a sign of user hesitation.

In the example shown in FIG. 2, if the user does not move between the plurality of screens and does not display the same screen many times before reaching the reservation completion page G, the conversion is performed by the shortest route. The straggle behavior can be described as a behavior that has not had the shortest path to conversion. When the straggle behavior occurs, it means that unnecessary behavior occurs before the conversion.

For example, if an error message is displayed on a place difficult to find in the reservation step 1 page E or the reservation step 2 page F (e.g., a place that is not displayed unless the page is scrolled), as in the case of the user U3, the straggle behavior occurs without noticing that there is missing information, and thus the user does not wish to continue and leaves the page halfway. As such, in this embodiment, in order to detect the problem in the layout of the website, the behavior history of each user is analyzed by the learning model to detect the straggle behavior.

The straggle behavior may be detected for any purpose, and is not limited to the purpose of detecting the problem in the layout. For example, the straggle behavior may be detected to identify the shortest path to reach the conversion. For example, in order to assist the user whose straggle behavior is detected, an operator may chat with the user or a guide message corresponding to the straggle behavior may be displayed. As another example, a plurality of layouts may be prepared for websites having the same content, and a website having a different layout may be presented to the user whose straggle behavior is detected.

The training data generating system S generates training data of a learning model that detects straggle behavior. The training data is a pair of a behavior history of a user whose access has been received and a label (hereafter referred to as straggle label) indicating whether it is a straggle behavior. In this regard, it is conceivable to prepare a detection rule for a straggle behavior in advance and automatically assign a straggle label using the detection rule to generate training data.

However, the more complex the structure of a website, the more behavior patterns that correspond to straggle behavior. As such, it is not practical to prepare detection rules that cover all the behavior patterns, and it is very difficult to automatically generate training data using the behavior patterns. If straggle labels are manually assigned to all the behavior histories stored in the server 10 to generate training data, it takes a lot of time and effort and is not efficient. Accordingly, the training data generating system S executes the following four steps in order to efficiently generate training data: (Step 1) Cluster behavior histories so that the behavior histories of similar content belong to the same cluster; (Step 2) Present the content of some of the behavior histories belonging to the cluster to an analyst, and allow the analyst to specify a straggle label; (Step 3) Assign the straggle label specified by the analyst to the cluster; and (Step 4) generate training data based on the straggle label of the cluster.

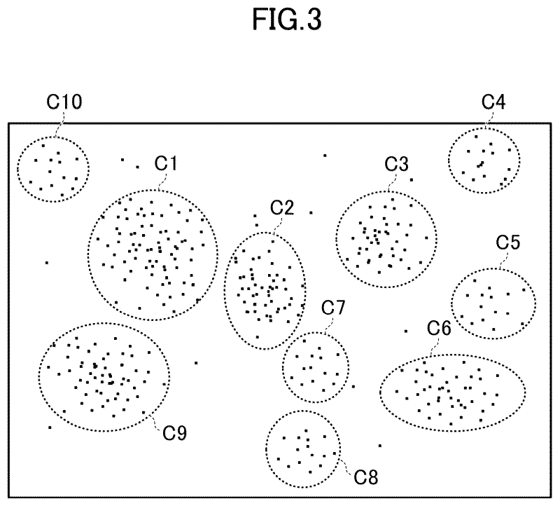

FIG. 3 shows an example of clustering. As shown in FIG. 3, in step 1, the training data generating system S quantifies the behavior histories stored in the server 10 and performs clustering. In the example of FIG. 3, feature amounts of the behavior histories are indicated in dots, and there are 10 clusters C1 to C10. The upper limit value of the number of clusters may or may not be determined.

For example, when the feature amount is represented by a multi-dimensional vector, if a distance between the feature amounts is short on a vector space, it means that the content of the behavior histories is similar. As such, clustering is performed so that the behavior histories close to each other belong to the same cluster. When the clustering is performed in the step 1, the process moves to the step 2, and a label assigning screen for assigning strangle labels is displayed on the analyst terminal 30.

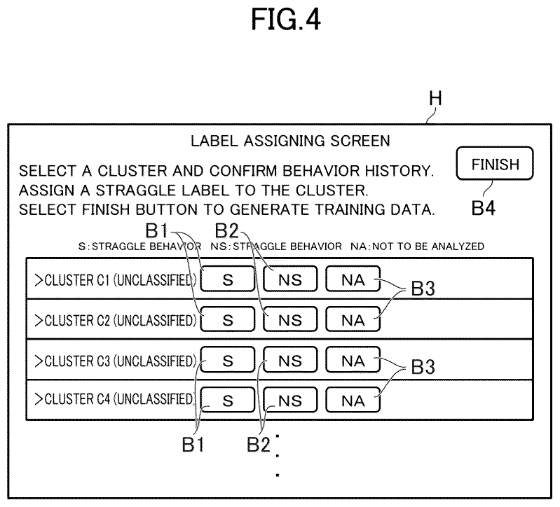

FIG. 4 shows an example of the label assigning screen. As shown in FIG. 4, the label assigning screen H displays a name of each of the clusters C1 to C10, buttons B1 to B3 for assigning straggle labels, and a button B4 for ending assignment of the straggle label. In this embodiment, assume that three types of straggle labels are prepared: “S” indicating straggle behavior; “NS” indicating non-straggle behavior; and “NA” indicating not to be analyzed.

The analyst selects one of the buttons B1 to B3 corresponding to each cluster to assign a straggle label. When a straggle label is assigned to a cluster, the label assigning screen H displays such information. In the example of FIG. 4, no cluster is assigned with a straggle label, and all the clusters are “unclassified”. For example, when the analyst selects the cluster C1, a list of behavior histories belonging to the cluster C1 is displayed.

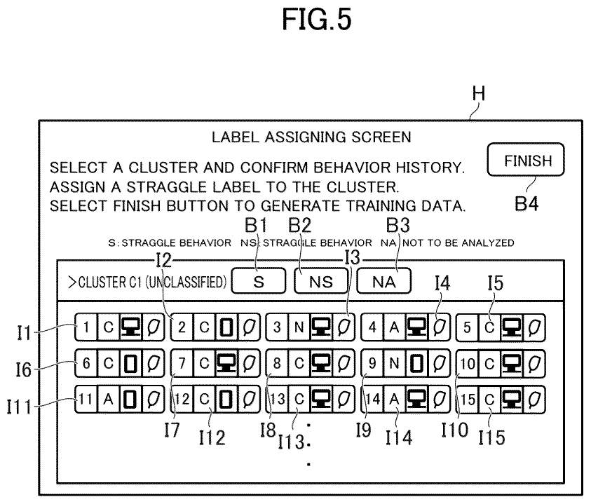

FIG. 5 is a diagram showing an example of the label assigning screen H when the analyst selects the cluster C1. As shown in FIG. 5, behavior history images I1 to I15 indicating the behavior histories belonging to the cluster C1 selected by the analyst are displayed. FIG. 5 fifteen behavior histories belonging to the cluster C1, but assume that a list of all the behavior histories belonging to the cluster C1 is displayed on the label assigning screen H. In the example of FIG. 5, each of the behavior history images I1 to I15 includes four icons, and the leftmost icon indicates a number sequentially assigned to the behavior histories belonging to the cluster C1. The second icon from the left indicates a label indicating whether the image has been converted (hereinafter referred to as a conversion label). In this embodiment, three types of conversion labels are prepared: “C” indicating being converted; “A” indicating being abandoned; and “N” indicating having no intention. In the example of FIG. 2, the users U1 and U2 are “C”, the user U3 is “A”, and the user U4 is “N”.

Even if the conversion labels are different, a distance between the feature amounts is short in a case where the behaviors until the session is disconnected are similar in general. As such, the behavior histories having conversion labels different from each other may belong to the same cluster. The conversion label may be assigned by the analyst, although in this embodiment, a domain knowledge for automatically assigning conversion labels is prepared. Details of the domain knowledge will be described later.

The third icon from the left is information indicating the type of a user terminal 20. In this embodiment, the web site provided by the server 10 has a layout for a desktop, a layout for a smartphone, and a layout for a tablet, and the user terminal 20 is classified as either a desktop, a smartphone, or a tablet. The rightmost icon is an icon for confirming content of the behavior history. The analyst selects an icon from the behavior history images I1-I15 and confirms the content of the behavior history.

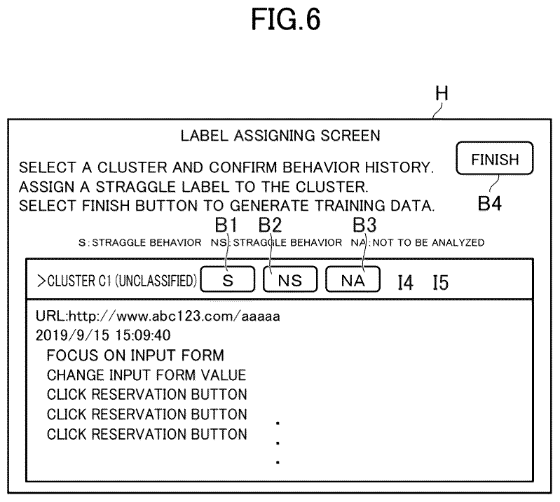

FIG. 6 shows how the content of the behavior history is displayed on the label assigning screen H. As shown in FIG. 6, when a behavior history belonging to the cluster C1 is selected, the content of the selected behavior history is displayed on the label assigning screen H. For example, the label assigning screen H displays the screen transition and the content entered by the user in time series during the period from the establishment of the session to the disconnection.

The analyst checks the content of the behavior history and determines whether the behavior corresponds to a straggle behavior. If it is not possible to determine the behavior only from the displayed behavior history, the analyst may return to the label assigning screen H of FIG. 5 and select another When the analyst selects one of the buttons behavior history. B1 to B3, a straggle label is assigned to the cluster C1. For example, when the analyst selects the button B1 in the state of FIG. 6, the straggle label “S” is assigned to the cluster C1.

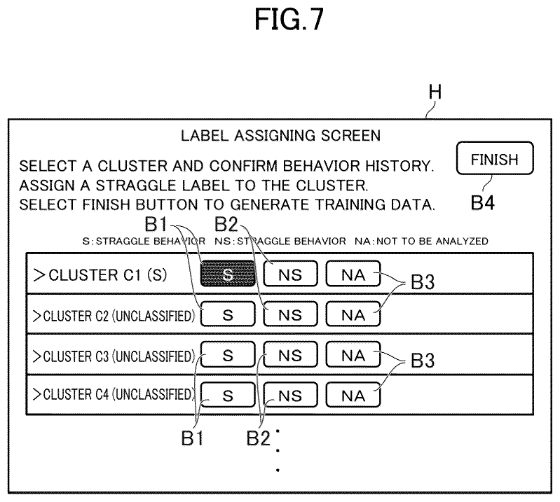

FIG. 7 is a diagram showing an example of the label assigning screen when a straggle label is assigned to the cluster C1. As shown in FIG. 7, the straggle label “S” is assigned to the cluster C1, and thus the name “S” is displayed next to the cluster C1. All the behavior histories belonging to the cluster C1 are classified as the straggle behavior.

In the same manner, the analyst also checks the content of some of the behavior histories of the clusters C2 to C10 to assign straggle labels, and repeats the step 3. When the analyst assigns the straggle labels to all the clusters and selects the button B4, a step 4 is executed. The training data generating system S then generates pairs of the behavior histories and the straggle labels belonging to the respective clusters as training data. The training data are learned by the learning model at any timing. Each time a new user's access is received, the trained learning model is used to classify whether the user's behavior is a straggle behavior.

As described above, the training data generating system S clusters the behavior histories stored in the server 10 and displays the content of some of the behavior histories belonging to the cluster on the label assigning screen H. The training data generating system assigns the straggle label specified by the analyst to each cluster and generates training data, thereby efficiently generating the training data. In the following, the training data generating system S will be described in detail.

### 3. Functions Implemented in this Embodiment

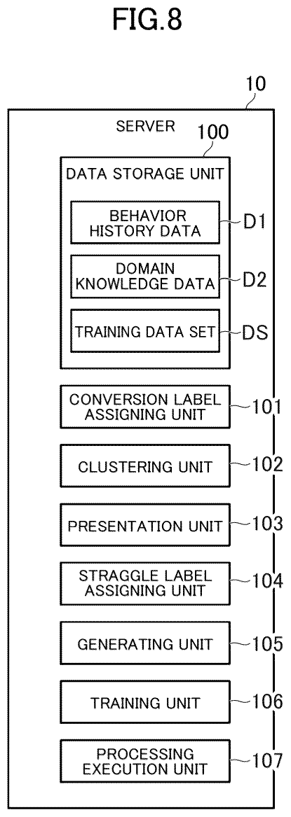

FIG. 8 is a functional block diagram illustrating an example of functions implemented by the training data generating system S. As shown in FIG. 8, in this embodiment, a case will be described in which a data storage unit 100, a conversion label assigning unit 101, a clustering unit 102, a presentation unit 103, a straggle label assigning unit 104, a generating unit 105, a training unit 106, and a processing execution unit 107 are implemented by the server 10.

### [3-1]. Data Storage Unit

The data storage unit 100 is implemented mainly by the storage unit 12. The data storage unit 100 stores data necessary for executing the processing described in this embodiment. For example, the data storage unit 100 stores behavior history data D1, domain knowledge data D2, and a training data set DS.

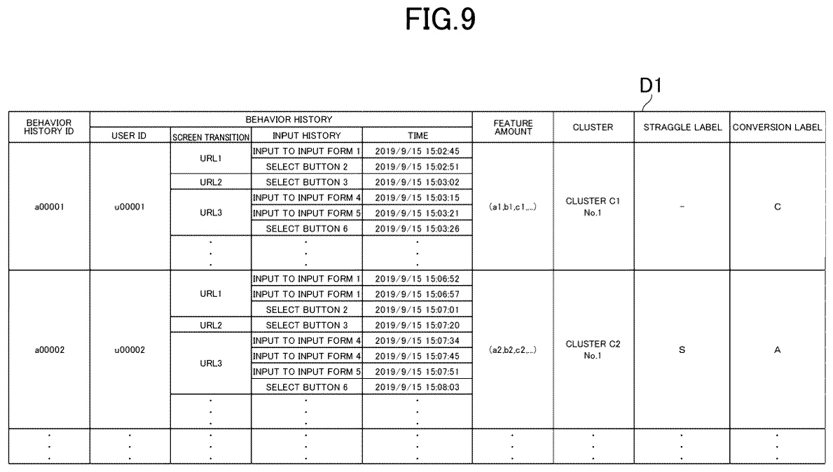

FIG. 5 is a diagram illustrating an example of data storage of the behavior history data D1. As shown in FIG. 9, the behavior history data D1 is data indicating behavior histories of respective users. The behavior history data D1 may store the behavior histories in all the past periods, or may store the behavior histories in a part of the periods. The behavior history data D1 may store the behavior histories of all the users or the behavior histories of only some of the users. The behavior history data D1 may store other information, such as information indicating the type of the user terminal 20.

For example, the behavior history data D1 stores a behavior history ID that uniquely identifies a behavior history, content of the behavior history, a feature amount of the behavior history, information about a cluster to which the behavior history belongs (e.g., a cluster ID that uniquely identifies the cluster and a number within the cluster), a straggle label assigned by the straggle label assigning unit 104, and a conversion label assigned by the conversion label assigning unit 101. Before clustering is executed, information about the cluster is not stored, and before a label is assigned, the straggle label and the conversion label are not stored.

For example, the behavior history shows the behavior of the user in time series. The behavior is an action of the user, and can be referred to as a log of the processing executed by the user terminal 20. In the example shown in FIG. 9, the user ID uniquely identifying the user, the content of the behavior history, and the time when the behavior is performed are stored as the behavior history. For example, the behavior history includes at least one of a screen transition by the user and a history of user input. In this embodiment, a case where both of them are included in the behavior history will be described, but only one of them may be included in the behavior history.

The screen transition is time-series changes of screens displayed on the user terminal 20. The screen transition can also be referred to as a browsing history. The screen transition may also be a history of screens displayed on the user terminal 20. In this embodiment, a case where a screen is identified by a URL will be described, but the screen may be identified by any information such as a screen ID.

The user input is input by the user to each screen. The user input can also be referred to as an operation history from the operation unit 24. For example, input may include an input to an input form, input to a button such as a radio button, selection of a link displayed on a screen, input to a drum roll UI, and scrolling on a screen.

For example, when the server 10 receives an access of the user, the server 10 generates a new record in the behavior history data D1, and stores the content of the behavior history and the current time together with the user ID. In this embodiment, the server 10 chronologically records a series of behaviors from the establishment of a session with the user terminal 20 to the disconnection, and stores the recorded behaviors as behavior histories. For example, the server 10 records a URL of a screen every time a screen displayed on the user terminal 20 is changed. For example, every time the server 10 receives an operation, such as an input to an input form from the user terminal 20, the server records the operation of the user.

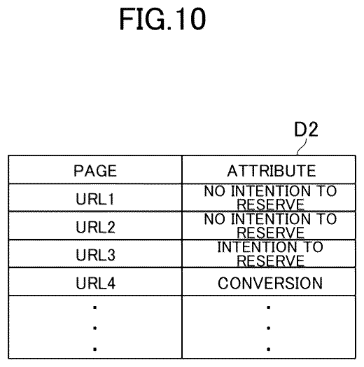

FIG. 10 shows an example of data storage of the domain knowledge data D2. As shown in FIG. 10, the domain knowledge data D2 stores various kinds of information about services provided by the server 10. For example, an attribute of each of the pages is stored in the domain knowledge data D2.

The attribute is a type of page, and in this embodiment, the attribute is used to assign a conversion label. For example, the attribute is information indicating a hierarchy of a page, and the upper hierarchical pages such as the top page A, the search form page B, the search result page C, and the course detail page D are given the attribute of “no intention to reserve”. For example, the intermediate hierarchical pages such as the reservation step 1 page E and the reservation step 2 page F are given the attribute of “having intention to reserve”. For example, hierarchical pages such as the reservation completion page G is given an attribute of “conversion”.

In this embodiment, when only the page with the attribute of “no intention to reserve” is displayed, a conversion label of “N” is assigned. When the page having the attribute of “intention to reserve” is displayed but the page with the attribute of “conversion” is not displayed, the conversion label of “A” is assigned. When the page with the attribute of “conversion” is displayed, the conversion label of “C” is assigned.

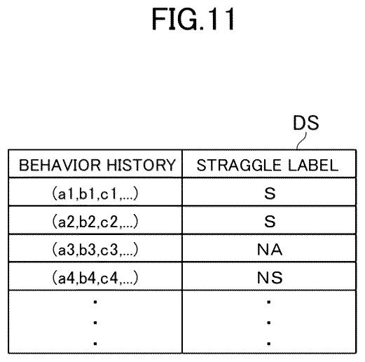

FIG. 11 shows an example of data storage of the training data set DS. As shown in FIG. 11, the training data set DS stores a large number of training data, which are pairs of inputs and outputs to be learned by the learning model. For example, each of training data stores a pair of a feature amount of a behavior history and a straggle label assigned to the behavior history. The training data set DS is generated by a generating unit 105 described later.

The data stored in the data storage unit 100 is not limited to the above example. For example, the data storage unit 100 stores programs and parameters of the learning model. The data storage unit 100 may store a learning model before learning or after learning. For example, the data storage unit 100 may store a user database in which basic information of users is stored. The user database stores personal information such as a name and an address of a user in association with a user ID. When a use registration for a service is registered by a user, a new record is created in the user database, and information of the user who has completed the use registration is stored.

### [3-2. Conversion Label Assigning Unit]

The conversion label assigning unit 101 is implemented mainly by the control unit 11. The conversion label assigning unit 101 assigns a conversion label, which is different from a straggle label, to each behavior history.

The straggle label is a label assigned to a cluster and can be referred to as a first label. The conversion label is a second label. As such, the part described as the straggle label in this embodiment can be replaced with the label assigned to a cluster or the first label, and the part described as the conversion label can be replaced with the second label.

The conversion label is a label showing a classification in a different viewpoint from the straggle label. The conversion label may be a label that is not at all related to the straggle label, but in this embodiment, the conversion label and the straggle label are related to each other. For example, the conversion label indicates a classification of the final behavior (conversion) of the user, while the straggle label indicates a classification of the intermediate behavior (straggle behavior) of the user.

The straggle label is a label assigned to a cluster, while the conversion label is a label assigned to an individual behavior history regardless of the cluster. In other words, the straggle label is a label assigned by the analyst based on the content of some of the behavior histories belonging to the cluster, while the conversion label is a label automatically assigned according to content of each behavior history. The behavior histories belonging to the same cluster have the same straggle label, but the conversion labels may be different from each other even if the behavior histories belong to the same cluster.

Assigning a conversion label to a behavior history indicates associating the conversion label with the behavior history. In this embodiment, the behavior history data D1 stores the conversion label. As such, storing information for identifying the conversion label in the same record as the behavior history corresponds to assigning the conversion label.

The conversion label assigning unit 101 assigns a conversion label based on the behavior history. For example, a rule for assigning a conversion label is determined in advance, and the conversion label assigning unit 101 assigns a conversion label based on the content of the behavior history and the assignment rule.

The assignment rule is stored in the data storage unit The assignment rule may be any form of data and may be 100. defined, for example, as part of a program code, or in the form of a formula or a table. The assignment rule may be set to any rule, such as, a screen displayed on the user terminal 20 and a screen in which the user inputs a predetermined input. The conversion label assigning unit 101 may assign a conversion label to every behavior history, or to some of behavior histories.

In this embodiment, three conversion labels of “C” (conversion), “A” (abandonment), and “N” (no intention) are prepared, and one of the conversion labels is assigned to each behavior history. For example, if the reservation completion page G is reached, a conversion label of “C” is assigned. For example, if the reservation step 1 page E or the reservation step 2 page F is reached but the reservation completion page G is not reached, a conversion label of “A” is assigned. For example, the reservation step 1 page E is not reached, a conversion label of “N” is assigned. In this embodiment, the assignment rule including these three conditions is prepared, and the conversion label assigning unit 101 assigns a conversion label associated with the condition that the behavior history satisfies.

The method of assigning a conversion label is not limited to the method based on the assignment rule. For example, as in a variation (3) described later, a second learning model for assigning a conversion label is prepared, and the conversion label assigning unit 101 may assign a conversion label using the second learning model. Further, for example, the conversion label may be manually specified by the analyst as in the case of the straggle label. In this case, the conversion label assigning unit 101 assigns conversion labels specified by the analyst to each behavior history.

### [3-3. Clustering Unit]

The clustering unit 102 is implemented mainly by the control unit 11. The clustering unit 102 clusters each of a plurality of behavior histories. A known clustering method can be used for clustering, and in this embodiment, the shortest distance method will be described as an example. The clustering method is not limited to the shortest distance method, and other hierarchical clustering methods such as the Ward's method, the longest distance method, the group and the centroid method may be used, or non-hierarchical clustering methods such as the K-Means method, the DBSCAN, and the Mean-shift may be used.

For example, the clustering unit 102 calculates a feature amount of each behavior history and performs clustering. The feature amount can be calculated by any calculation formula, and is calculated, for example, by digitizing the feature by a predetermined calculation formula. The clustering unit 102 calculates a distance of a feature amount of each behavior history, and performs clustering so that behavior histories close to each other belong to the same cluster. There may be a behavior history that does not belong to any cluster because outliers (noise) may exist. Such behavior history is not assigned with a strangle flag, and thus is not used as training data.

### [3-4. Presentation Unit]

The presentation unit 103 is implemented mainly by the control unit 11. The presentation unit 103 presents to the analyst content of some of the behavior histories belonging to the cluster.

Some of the behavior histories belonging to the cluster means the behavior histories smaller than the total number of behavior histories belonging to the cluster. For example, if n (n: an integer greater than or equal to 2) number of behavior histories belong to the cluster, some of the behavior histories means any number of behavior histories of n−1 or less. The presentation unit 103 may present content of only one behavior history or content of n−1 behavior histories. If the analyst requests to check content of all behavior histories for a certain cluster, the presentation unit 103 may present the content of all the behavior histories for such a cluster.

The presentation unit 103 may present a behavior history in a manner perceptible to the analyst, for example, may visually present using an image, or audibly present using sound. The presentation unit 103 may present the behavior histories of all the clusters, or may present the behavior histories of some of the clusters. For example, the presentation unit 103 may not present the behavior histories of the cluster that is not selected by the analyst.

In this embodiment, the presentation unit 103 presents content of some of the behavior histories that belong to the cluster specified by the analyst. The presentation unit 103 does not present the content of the behavior histories of the cluster that is not specified by the analyst. For example, the presentation unit 103 presents a plurality of clusters on the label assigning screen selectable manner. The presentation unit 103 presents the content of some of the behavior histories belonging to the cluster selected by the analyst. The analyst may specify one cluster or a plurality of clusters. Further, the analyst may specify all of the clusters or some of the clusters.

In this embodiment, the presentation unit 103 presents the content of the behavior history specified by the analyst among the plurality of behavior histories. The presentation unit 103 does not present the content of the behavior history that is not specified by the analyst. For example, the presentation unit 103 presents a plurality of behavior histories belonging to a cluster on the label assigning screen H in a selectable manner. The presentation unit 103 presents the content of the behavior history selected by the analyst. The analyst may specify one behavior history or a plurality of behavior histories. Further, the analyst basically specifies only some of the behavior histories, but if the number of the behavior histories belonging to the cluster is small, the analyst may specify all the behavior histories to check the content.

In this embodiment, the presentation unit 103 further presents to the analyst the conversion labels assigned to some of the behavior histories. The presentation unit 103 presents the conversion labels assigned to the behavior histories on the label assigning screen H. For example, as shown in FIG. 5, the presentation unit 103 presents the conversion labels by icons indicating the characters “C”, “N”, and “A”. The presentation unit 103 may present the conversion label before or after the analyst selects the content of the behavior history. The analyst specifies the straggle label by referring not only to the content of the behavior history but also to the content of the conversion label.

### [3-5. Straggle Label Assigning Unit]

The straggle label assigning unit 104 is implemented mainly by the control unit 11. The straggle label assigning unit 104 assigns a straggle label specified by the analyst to a cluster.

To assign a strangle label to a cluster is to associate the strangle label with the cluster. In this embodiment, straggle labels are stored in the behavior history data D1, and thus, storing a straggle label in the same record as a behavior history belonging to the cluster corresponds to assigning the straggle label. In this embodiment, a straggle label of “S” (straggle behavior), “NS” (non-straggle behavior), or “NA” (not analyzed) is assigned.

In this embodiment, the behavior history of the user in the past is described as an example of an object to be classified, and thus the label assigned to the cluster is a label indicating whether a specific behavior has been performed. In this embodiment, the specific behavior is a straggle behavior in which at least one of a screen transition and an input is repeated without reaching a predetermined screen. The specific behavior is not limited to a straggle behavior, but may be a behavior that is desired to be detected by the learning model, for example, an illegal behavior that violates the rules or an excellent behavior that serves as a model. As another example, the most efficient behavior to reach the conversion screen may correspond to the specific behavior.

The straggle label assigning unit 104 assigns straggle labels to some of the behavior histories presented by the presentation unit 103 and to the other behavior histories belonging to the same cluster as the some of the behavior histories. The other behavior histories are behavior histories that are not presented by the presentation unit 103. In this embodiment, the straggle label assigning unit 104 assigns straggle labels to all of the behavior histories belonging to the cluster, although some of the clusters may have behavior histories that are not assigned with the straggle labels. For example, a behavior history far from the centroid of the cluster may not be assigned with a straggle label. In this embodiment, the straggle label assigning unit 104 assigns straggle labels to all of the clusters, although some of the clusters may not assigned with the straggle labels. For example, a cluster having a small number of behavior histories may not be assigned with a straggle label. Further, a cluster that is not specified by the analyst may be automatically assigned with “NA” (not analyzed).

In this embodiment, the straggle label assigning unit 104 assigns a straggle label to a cluster specified by the analyst. The straggle label assigning unit 104 does not assign a straggle label to a cluster that is not specified by the analyst. For example, on the label assigning screen H, a plurality of clusters are presented in a selectable manner, and the straggle label assigning unit 104 assigns a straggle label to the cluster selected by analyst.

In this embodiment, the straggle label assigning unit 104 assigns a straggle label to a cluster to which the behavior history specified by the analyst belongs. The straggle label assigning unit 104 does not assign a straggle label to a cluster in which none of the behavior histories is specified by the analyst. For example, on the label assigning screen H, behavior histories belonging to clusters are presented in a selectable manner, and the straggle label assigning unit 104 assigns a straggle label to a cluster to which a behavior history selected by analyst belongs.

The straggle label is given to a cluster, and is different from a cluster ID that identifies the cluster itself. The same cluster ID may not be assigned to a plurality of clusters, although the same straggle label may be assigned to a plurality of clusters. If the same straggle label is specified for one cluster and the other cluster by the analyst, the straggle label assignment unit 104 assigns the same straggle label to each of the one cluster and the other cluster. In this case, the same straggle label is assigned regardless of a distance between the one cluster and the other cluster.

### [3-6. Generating Unit]

The generating unit 105 is implemented mainly by the control unit 11. The generating unit 105 generates training data to be learned by the learning model based on the straggle label assigned by the straggle label assigning unit 104. For each behavior history belonging to the cluster to which a straggle label is assigned, the generating unit 105 generates a pair of a feature amount of such a behavior history and the assigned straggle label as training data. The generating unit 105 generates training data for all of the clusters that are assigned with the straggle labels and stores the training data in the data storage unit 100 as the training data set DS.

In this embodiment, the generating unit 105 generates training data for all of the behavior histories in the cluster to which the straggle label is assigned, although training data may not be generated for some of the behavior histories. For example, if the number of behavior histories belonging to the cluster is large, the generating unit 105 may generate training data only for a certain number of behavior histories. For example, if the number of behavior histories varies depending on the clusters, the generating unit 105 may adjust so that the difference in the number of training data between the clusters does not become too large.

### [3-7. Training Unit]

The training unit 106 is implemented mainly by the control unit 11. The training unit 106 executes the learning process of the learning model based on the training data set DS. The learning process itself can use a known method used in the machine learning, for example, a learning process used in a neural network. A program of the learning process is stored in the data storage unit 100. The training unit 106 adjusts parameters of the learning model so that the relationship between the input and the output of the training data stored in the training data set DS is obtained. The learning model in which the training data set DS is learned is stored in the data storage unit 100 and is used for analyzing a behavior of a user.

### [3-8. Processing Execution Unit]

The processing execution unit 107 is implemented mainly by the control unit 11. The processing execution unit 107 executes predetermined processing based on the learning model trained by the training unit 106. The predetermined processing may be any processing corresponding to the use of the learning model, and, in this embodiment, is the behavior analysis of a user. Upon receiving an access from a user, the processing execution unit 107 obtains a behavior history of the user and inputs the feature amount of the behavior history in the learning model. The feature amount may be calculated by the learning model. The learning model outputs a straggle label corresponding to the feature amount, and the processing execution unit 107 assigns the output straggle label to the behavior history of the user. For example, the processing execution unit 107 displays the behavior history classified as “S”, which is the straggle behavior, on the analyst terminal 30, and the analyst specifies a page having a problem with the layout.

### 4. Processing Executed in this Embodiment

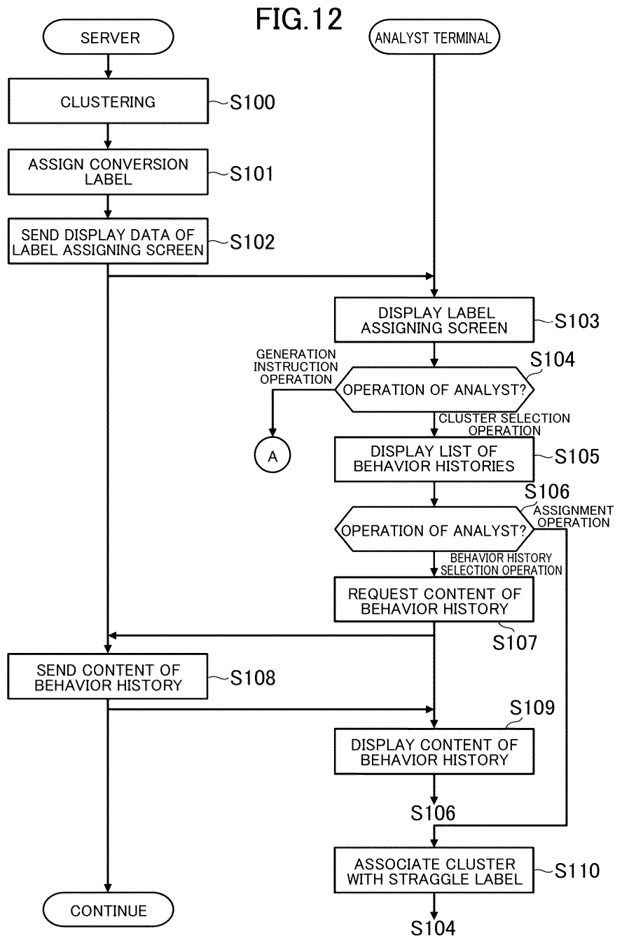

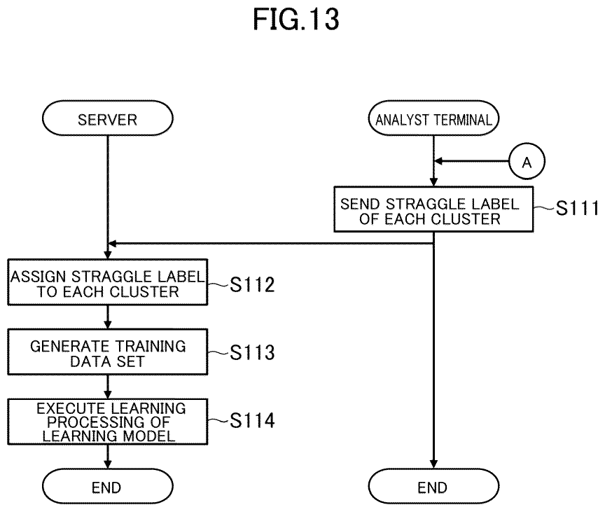

FIGS. 12 and 13 are flow chart showing an example of processing executed in the training data generating system S. The processing shown in FIGS. 12 and 13 is executed when the control units 11 and 31 operate in accordance with the programs respectively stored in the storage units 12 and 32.

The processing shown in FIGS. 12 and 13 can be executed at any timing, for example, when a predetermined date and time comes, or when the analyst instructs to start the processing. When the processing shown in FIGS. 12 and 13 is executed, assume that the behavior histories of the user who has accessed the server 10 are stored in the behavior history data D1.

As shown in FIG. 12, the server 10 clusters each of the behavior histories based on the behavior history data D1 (S100). In S100, the server 10 calculates a feature amount of each behavior history stored in the behavior history data D1. The server 10 calculates a distance of a behavior history based on the feature amount of the behavior history. The server 10 clusters the behavior histories so that the behavior histories close to each other belong to the same cluster. The server 10 assigns a cluster ID of a cluster, to which a behavior history belongs, to the behavior history. The cluster ID is not assigned to the outlier behavior history that does not belong to any cluster.

The server 10 assigns a conversion label to each behavior history based on the domain knowledge data D2 (S101). In S101, the server 10 assigns a conversion label of “N” (no intention) to the behavior history that does not reach the reservation step 1 page E. The server 10 assigns a conversion label of “A” (abandonment) behavior history that reaches the reservation step 1 page E or the reservation step 2 page F but does not reach the reservation completion page G. The server 10 assigns a conversion label of “C” (conversion) to the behavior history that reaches the reservation completion page G. The server 10 stores the conversion labels of the respective behavior histories in the behavior history data D1.

The server 10 generates display data for the label assigning screen H based on the behavior history data D1 and sends the generated data to the analyst terminal 30 (S102). The display data may be any data format, for example, HTML data if the label assigning screen H is displayed on a browser. In S102, the server 10 specifies the cluster created by the clustering based on the behavior history data D1, and generates the display data of the label assigning screen H shown in FIG. 4. On the label assigning screen H, each cluster is selectable. The display data includes information necessary to display the label assigning screen H of FIGS. 4 and 5, such as, names of clusters, behavior history IDs of respective behavior histories belonging to the clusters, and image data of behavior history images I.

The analyst terminal 30 receives the display data and displays the label assigning screen H on the display unit 35 (S103). At this point, a straggle label is not assigned to any cluster, and each cluster is “unclassified” as shown in FIG. 4.

The analyst terminal 30 specifies an operation of the analyst based on a detection signal of the operation unit 34 (S104). In S104, either a cluster selection operation for selecting a cluster displayed on the label assigning screen H or a generation instruction operation for instructing generation of training data by selecting the button B4 is performed.

If the cluster selection operation is performed (S104; cluster selection operation), the analyst terminal 30 displays a list of behavior histories belonging to the cluster selected by the analyst on the label assigning screen H (S105). In S105, as shown in the label assigning screen H of FIG. 5, a list of behavior history images I is displayed.

The analyst terminal 30 specifies an operation of the analyst based on a detection signal of the operation unit 34 (S106). In S106, either a behavior history selection operation for selecting a behavior history from the list or an assignment operation for assigning a straggle label by selecting one of the buttons B1 to B3 is performed.

If the behavior history selection operation is performed (S106; behavior history selection operation), the analyst terminal 30 requests the server 10 for the content of the behavior history selected by the analyst (S107). The request in S107 includes a behavior history ID of the behavior history selected by the analyst.

Upon receiving the request, the server 10 sends the content of the behavior history selected by the analyst to the analyst terminal 30 based on the behavior history data D1 (S108). In S108, the server 10 refers to a record in which the behavior history ID included in the request is stored, and sends the content of the behavior history of the record.

Upon receiving the content of the behavior history, the analyst terminal 30 displays the content on the label assigning screen H (S109), and returns to S106. In S109, the label assigning screen H shown in FIG. 6 is displayed. When the analyst selects another behavior history, the processing of S107 is repeated, and the content of such a behavior history is displayed on the label assigning screen H.

If any of the buttons B1 to B3 is selected in S106 to perform an assignment operation (S106; assignment operation), the analyst terminal 30 associates the cluster selected by the analyst with the straggle label specified by the analyst (S110), and returns to S104. At S110, the straggle label may be stored in the behavior history data D1 in the server 10, although in this embodiment, the straggle label is stored in the behavior history data D1 after the button B4 is selected.

When the button B4 is selected and the generation instruction operation is performed in S104 (S104; generation instruction operation), the process proceeds to FIG. 13, and the analyst terminal 30 sends a straggle label of each cluster to the server 10 (S111). For example, the straggle labels associated with the respective clusters in S110 are stored in the storage unit of the analyst terminal 30, and the data set for such association is sent to the server 10 in S111.

Upon receiving the straggle labels, the server 10 assigns the straggle labels specified by the analyst to the respective clusters (S112). In S112, the server 10 updates the behavior history data D1 such that all of the behavior histories belonging to the respective clusters are associated with the straggle labels specified by the analyst.

The server 10 generates a training data set DS based on the behavior history data D1 (S113). In S113, for each behavior history assigned with a straggle label, the server 10 generates training data, which is a pair of a feature amount of the behavior history and the straggle label. The server 10 stores training data of each behavior history assigned with a straggle label in the training data set DS.

The server 10 executes the learning process of the learning model based on the training data set DS (S114), and the processing terminates. In S114, the server 10 adjusts the parameters of the learning model so that the relationship between the input and the output of each training data stored in the training data set DS is obtained. Subsequently, the trained learning model is stored in the server 10, and the behavior of the user who has accessed the server 10 is analyzed.

The training data generating system S described above presents the content of some of the behavior histories to the analyst so as to make the analyst to specify a straggle label, and generates training data based on the straggle label assigned to the cluster. This allows the analyst only to specify a straggle label for a cluster instead of specifying straggle labels for respective behavior histories, and thus the time and effort of the analyst can be reduced and the training data can be efficiently generated. For example, if 1000 behavior histories belong to a cluster, the analyst can check some of the behavior histories and assign straggle labels to these 1000 behavior histories at a time. Further, the behavior histories belonging to the same cluster are similar to each other, and thus it is unlikely that the behavior histories having different straggle labels are mixed. Even if the behavior histories having different straggle labels are mixed in the same cluster, the number of such behavior histories is small and treated as an exception in the learning process. As such, the effect on the accuracy of the learning model is small. Accordingly, the accuracy of the learning model can be secured.

Further, the content of some of the behavior histories belonging to the cluster specified by the analyst among the plurality of clusters are presented, and the straggle label is assigned to the cluster specified by the analyst, and thus the straggle label can be efficiently assigned. For example, the analyst can select the clusters that the analyst wants to check one by one and assign straggle labels, and thus the straggle labels can be efficiently assigned. For example, if the number of behavior histories in a cluster is small, a straggle label may not be assigned to such a cluster because the accuracy of the training data is not significantly affected. As such, the analyst may not select a cluster for which a straggle label is not specified.

Further, the content of some of the behavior histories specified by the analyst among the plurality of behavior histories are presented, and the straggle label is assigned to the cluster specified by the analyst, and thus the straggle label can be efficiently assigned. For example, the analyst is allowed to select the behavior history that the analyst wants to check, and thereby the accuracy of the straggle label can be increased.

If the same straggle label is specified for one cluster and another cluster by the analyst, the same straggle label is assigned to these clusters, and thereby the number of training data can be increased and the accuracy of the learning model can be improved.

Further, a conversion label different from the straggle label is assigned to some of the behavior histories, and conversion labels of behavior histories belonging to respective clusters are displayed, and thus the analyst can specify the straggle label referring to the conversion label, which serves to efficiently specify the straggle label.

As described in the embodiment, when a behavior history corresponds to a classification object, the process of generating training data from the behavior history can be efficiently performed.

Further, as described in the embodiment, when the behavior in which at least one of the screen transition and the input is repeated without reaching a predetermined screen corresponds to a specific behavior, the training data can be efficiently generated even if there are a lot of such behavior patterns.

### 5. Variations

The present disclosure is not to be limited to the above described embodiment. The present disclosure can be changed as appropriate without departing from the spirit of the invention.

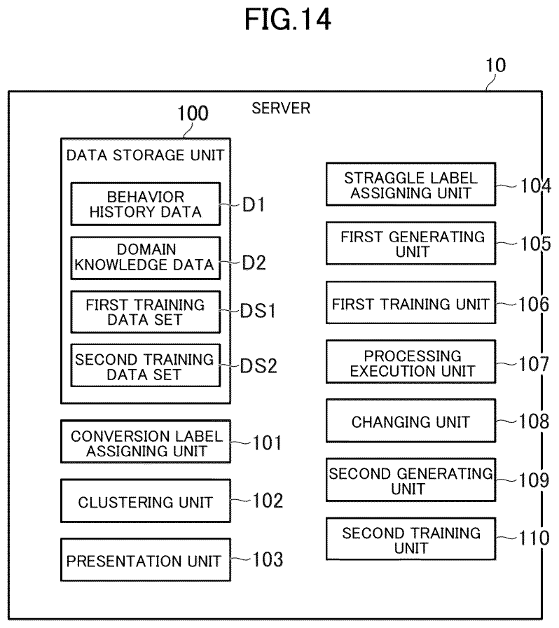

FIG. 14 is a functional block diagram of a variation. As shown in FIG. 14, in the variation, a changing unit 108, a second generating unit 109, and a second training unit 110 are implemented. In the variation, for purposes of explanation, the training data set DS explained in the embodiment is described as a first training data set DS1, the generating unit 105 is described as a first generating unit 105, and the training unit 106 is described as a first training unit 106.

(1) For example, in the embodiment, the analyst is allowed to select any cluster on the label assigning screen H, although the analyst may be allowed to specify a conversion label so as to display the cluster having many behavior histories of such a conversion label on the label assigning screen H.

In this variation, the server 10 aggregates the conversion labels of the behavior histories belonging to the respective clusters based on the behavior history data D1, and records the aggregated results in the data storage unit 100. For example, the server 10 calculates, for each cluster, the number or percentage of behavior histories to which respective conversion labels are assigned, and stores the calculated results in the data storage unit 100.

The presentation unit 103 selects the cluster based on the conversion label specified by the analyst, and presents the content of some of the behavior histories belonging to the selected cluster. The analyst may specify the conversion label on the label assigning screen H, or specify the conversion label on another screen.

For example, the presentation unit 103 selects the cluster that has the highest number or percentage of the conversion labels specified by analyst. For example, the presentation unit 103 selects clusters up to a predetermined number in order of the number or the percentage of conversion labels specified by the analyst. For example, the presentation unit 103 selects clusters in which the number or the percentage of conversion labels specified by the analyst is a threshold value or more. The presentation unit 103 displays a behavior history image I of the behavior history belonging to the selected cluster. The processing after the behavior history image I is displayed is the same as in the embodiment, where the content of the behavior history selected by the analyst is presented and a straggle label is assigned to the cluster.

According to the variation (1), a cluster is selected based on the conversion label specified by analyst, and the content of some of the behavior histories belonging to the selected cluster are presented, thereby the straggle label can be efficiently specified.

(2) For example, the conversion label assigned to the behavior history may be changed by the analyst. For example, when a second icon from the left of a behavior history image I (icon indicating the letter “C”, “A”, or “N”) is clicked in the label assigning screen H shown in FIG. 5, the conversion label of the behavior history may be changed.

The training data generating system S of the variation (2) includes the changing unit 108. The changing unit 108 is implemented mainly by the control unit 11. The changing unit 108 changes the conversion labels assigned to some of the behavior histories based on the operation of the analyst. The operation for changing the conversion label may be any operation. In this variation, the operation for the label assigning screen H will be described, although the operation for the other screen may be used. That is, the user interface for changing the conversion label is not limited to the label assigning screen H, but any user interface can be used. The changing unit 108 updates the behavior history data D1, and changes the conversion label assigned to the behavior history to the conversion label specified by the analyst.

According to the variation (2), the conversion labels assigned to some of the behavior histories is changed based on the operation of the analyst, and the conversion label assigned in error can thereby be corrected.

(3) For example, in the embodiment, the conversion label is assigned to the behavior history based on the domain knowledge data D2, although the second learning model that automatically assigns a conversion label may be prepared. In this case, the training data generating system S may generate a second training data set DS2 to be learned by the second learning model based on the content of the domain knowledge data D2.

The conversion label assigning unit 101 of the present variation assigns a conversion label to each behavior history based on the predetermined condition as described in the embodiment. The predetermined condition is a condition included in the assignment rule, and, as described in the embodiment, any condition may be determined.

The training data generating system S of the present variation includes a second generating unit 109 and a second training unit 110. These units are implemented mainly by the control unit 11. The second generating unit 109 generates second training data to be learned by the second learning model based on the conversion labels assigned to the respective behavior histories. The second learning model is different from the learning model described in the embodiment. The second learning model is a learning model for assigning a conversion label to a behavior history.

The second training data is a pair of content of a behavior history and a conversion label. For each behavior history belonging to a cluster and assigned with a conversion label, the second generating unit 109 generates a pair of a feature amount of the behavior history and the conversion label as training data. The second generating unit 109 generates training data for all of the behavior histories that are assigned with the conversion labels, and stores the training data in the data storage unit 100 as the second training data set DS2.

The second training unit 110 executes the learning process of the second learning model based on the second training data set DS2. Similarly to the first learning model, the learning process itself can use a known method used in the machine learning, for example, a learning process used in a neural network. The second training unit 110 adjusts parameters of the second learning model so that the relationship between the input and the output of the training data stored in the second training data set DS2 is obtained. The trained second learning model is stored in the data storage unit 100, and used by the conversion label assigning unit 101.

According to the variation (3), it is possible to efficiently generate the second training data by generating the second training data to be learned by the second learning model based on the conversion label assigned to the behavior history. Further, the second learning model learns the content of the domain knowledge data D2, and the conversion label can be thereby assigned even if the server 10 does not store the domain knowledge data D2.

(4) For example, two or more of the above described variations may be combined.

For example, input/output pairs to be correct are called training data, and a group of such pairs is called training data set, although a group of such pairs may correspond to training data. In other words, the training data may be a pair of an input and an output, or data indicating a group of pairs. For example, the behavior history is not limited to screen transition and input, but may indicate a history of any behavior. For example, the behavior history may be a purchase history of goods by the user or a history of applying services by the user. The service is not limited to reservation of a golf course. For example, the service may be any service such as a travel booking service, an insurance service, or a financial service.

For example, the case has been described in which the analyst selects a cluster on the label assigning screen H, although the cluster may be automatically selected and the analyst may specify some of the behavior histories belonging to the cluster. For example, the case has been described in which the analyst selects the behavior history for which the analyst wants to check the content, although the content of the cluster presented to the analyst may be automatically selected. Further, for example, a conversion label may also be used as one of feature amounts of behavior histories. For example, a conversion label may not be assigned to a behavior history.

For example, the case has been described in which the classification object is the user's behavior history, although the classification object may be any data as described above. For example, if the classification object is an image, a label assigned to the cluster indicates a type of an object, such as a dog and a cat. The training data generating system S clusters the feature amounts of the images, and presents some of the images of the cluster to the analyst. The training data generating system S assigns a label specified by the analyst to each image belonging to the cluster, and generates training data of the learning model to detect objects.

For example, if the classification object is text or content, a label assigned to a cluster indicates a type of text or content. The training data generating system S clusters feature amounts of the text or content, and presents some of the text or content of the cluster to the analyst. The training data generating system S assigns the label specified by the analyst to each text or content belonging to the cluster, and generates training data of the learning model to classify the text or content.

For example, the case has been described in which the functions are implemented in the server 10, although the functions may be shared among a plurality of computers. For example, the functions may be shared between the server 10, the user terminal 20, and the analyst terminal 30, or shared among a plurality of server computers. In this case, the functions may be shared by sending and receiving the processing results through a network. For example, the data described as being stored in the data storage unit 100 may be stored in a computer other than the server 10. For example, the training unit 106 (first training unit 106 in the variation) and the second training unit 110 may be implemented by an external system so that the learning process is not executed in the training data generating system S.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A training data generating system comprising:
at least one memory configured to store computer program code; and
at least one processor configured to operate as instructed by the computer program code, the computer program code including:
second label assigning code configured to cause at least one of the at least one processor to assign a second label that is different from a first label to each of a plurality of classification objects based on content of each of the plurality of classification objects;
clustering code configured to cause at least one of the at least one processor to calculate a feature amount of each of the plurality of classification objects and cluster each of a plurality of classification objects into a plurality of clusters based on the feature amount of each of the plurality of classification objects;
displaying code configured to cause at least one of the at least one processor to select one or more selected clusters from among the plurality of clusters based on a number or percentage of the classification objects associated with the second label designated by an analyst and display an image in a display, the image indicating content of some of the classification objects belonging to the one or more selected clusters;
first label assigning code configured to cause at least one of the at least one processor to assign a designated first label that is the first label designated by the analyst in the display to the one or more selected clusters that the content belongs to, wherein the first label includes at least one of: conversion, abandonment, and no intention, and wherein the second label includes at least one of: straggle, non-straggle, not-to-be-analyzed, a desired behavior, an undesired behavior, or a most efficient behavior;
generating code configured to cause at least one of the at least one processor to generate pairs of the classification objects that belongs to the one or more selected clusters and the designated first label as training data to be learned by a learning model.

2. The training data generating system according to claim 1, wherein:
the classification object is a screen transition of a user,
the first label indicates a struggle label indicating whether or not at least one of the screen transition and an input has been repeated without reaching a predetermined screen, and
the second label is a conversion label indicating whether or not the predetermined screen has been reached.

3. The training data generating system according to claim 1, wherein the displaying code is further configured to cause at least one of the at least one processors to select the one or more selected clusters up to a predetermined number in order of the number or the percentage.

4. The training data generating system according to claim 1, wherein the displaying code is further configured to cause at least one of the at least one processors to select the one or more selected clusters in which the number or the percentage is a threshold value or more.

5. The training data generating system according to claim 1, wherein:
the displaying code is further configured to cause at least one of the at least one processors to display the image that indicates the content of some of the classification objects belonging to the cluster specified by the analyst among the plurality of clusters; and
the first label assigning code is further configured to cause at least one of the at least one processors to assigns the first label to the cluster specified by the analyst.

6. The training data generating system according to claim 1, wherein:
the displaying code is further configured to cause at least one of the at least one processors to display the image that indicates the content of the classification object specified by the analyst among the plurality of classification objects; and
the first label assigning code is further configured to cause at least one of the at least one processors to assign the first label to the cluster to which the classification object specified by the analyst belongs.

7. The training data generating system according to claim 1, wherein the first label assigning code is further configured to cause at least one of the at least one processor to, based on the analyst assigning a same first label to one cluster and another cluster, assign the same first label to the one cluster and the another cluster.

8. The training data generating system according to claim 1, wherein the displaying code is further configured to cause at least one of the at least one processors to display the image that indicates the second label assigned to some of the classification objects to the analyst.

9. The training data generating system according to claim 8, wherein the second label assigning code is further configured to cause at least one of the at least one processor to change the second label assigned to some of the classification objects based on an operation of the analyst.

10. The training data generating system according to claim 1, wherein the generating code is further configured to cause at least one of the at least one processor to generate pairs of each of plurality of the classification objects and the second label assigned to each of plurality of the classification objects.

11. The training data generating system according to claim 1, wherein
the classification objects are behavior histories performed in a past by a user; and
the first label indicates whether a specific behavior is performed.

12. The training data generating system according to claim 11, wherein
each of the behavior histories includes at least one of a screen transition by the user or a history of input by the user, and
the specific behavior is repeating at least one of the screen transition or the input without reaching a predetermined screen.

13. A training data generating method, comprising:
assigning a second label that is different from a first label to each of a plurality of classification objects based on content of each of the plurality of classification objects;
calculating a feature amount of each of the plurality of classification objects and clustering each of a plurality of classification objects into a plurality of clusters based on the feature amount of each of the plurality of classification objects;
select one or more selected clusters from among the plurality of clusters based on a number or percentage of the classification objects associated with the second label designated by an analyst and display an image in a display, the image indicating content of some of the classification objects belonging to the one or more selected clusters;
assigning a designated first label that is the first label designated by the analyst in the display to the one or more selected clusters;
generating pairs of the classification objects that belongs to the one or more selected clusters and the designated first label as training data to be learned by a learning model.

14. A non-transitory information storage medium storing program code that, when executed by at least one of at least one processor, causes the at least one processor to:
assign a second label that is different from a first label to each of a plurality of classification objects based on content of each of the plurality of classification objects;
calculate a feature amount of each of the plurality of classification objects and cluster each of a plurality of classification objects into a plurality of clusters based on the feature amount of each of the plurality of classification objects;
select one or more selected clusters from among the plurality of clusters based on a number or percentage of the classification objects associated with the second label designated by an analyst and display an image in a display, the image indicating content of some of the classification objects belonging to the one or more selected clusters;
assign a designated first label that is the first label designated by the analyst in the display to the one or more selected clusters;
generate pairs of the classification objects that belongs to the one or more selected clusters and the designated first label as training data to be learned by a learning model.
